(19) United States
(12) Patent Application Publication
(10) Pub. No.: US 2005/0205680 A1
(43) Pub. Date: Sep. 22, 2005

(54) Water Saver

(75) Inventor: Gregory Martin Valente, Greenville, SC (US)

Correspondence Address: GREGORY M. VALENTE, 833 ALTAMONT ROAD, GREENVILLE, SC, 29609, US

(73) Assignee: Miss. Gregory Martin Valente, Greenville, SC (US)

(21) Appl. No.: 10/708,727

(22) Filed: Mar. 19, 2004

(51) Int. Cl. G05D 23/185; F25B 15/00

(52) U.S. Cl. 236/12.11

(57) ABSTRACT

An apparatus for conserving water in a household or commercial plumbing installation. Water temperature is monitored preceding the delivery point (e.g. faucet), and water is automatically diverted and locally stored until it reaches a predetermined desired temperature. The stored water is incrementally returned to the delivery point at times when temperature is of no concern.

### COPYRIGHT STATEMENT

Copyright 2004 Gregory Martin Valente

### BACKGROUND OF INVENTION

1. Field of the Invention

This invention relates generally to methods for conserving water, and, more particularly, to reducing water usage and waste in residential and commercial plumbing installations.

2. Description of the Related Art

A plumbing installation typically consists of a hot and cold-water delivery system, where hot and cold water are delivered to a water outlet (for example a faucet) by means of piping and one or more valves between the water supply and the outlet point. It is customary to provide a means of turning off the water supply near the water outlet point. This is usually done by means of an installed shutoff valve for each of the hot and cold water supply lines, from which the piping is then connected to a faucet or other water delivery mechanism. The delivery mechanism may be a single handle, or dual handle device (one each for hot and cold water) and may have either one or two outlet points (though one is typical in modern installations).

Hot water is usually generated by means of a water heater, and cold water is typically supplied at the temperature of the local or regional public water supply. Usually the water heater is located in the same building as, but not in the same room as the water outlet, and the water is delivered from the water heater to the outlet point via piping. Often the piping is made from copper, and frequently it is not insulated.

When there is no water flow in the system, the water that is contained in the piping between the water heater and the outlet point can cool due to lower ambient temperatures in the areas where the pipes are routed. As a result of this cooling effect, when water is drawn at the outlet point, it may not be at the same temperature as the water contained in the water heater.

When a hot water faucet or other delivery device is opened at the outlet point, it is the expectation of the person operating the system that hot water will then be delivered. But, due to the lower temperature of the water in the pipes between the water heater and outlet point, it often takes some time. The water in the pipes between the water heater and the outlet point must be purged before hot water reaches the outlet point.

Depending on the distance from the water heater to the outlet point and the diameter of the supply piping, a significant amount of water must be purged from the piping system before hot water begins to flow at the outlet point. This water is often needlessly drained away.

The need to conserve water in plumbing systems has been pointed out, and, in prior art, some remedies have been suggested. For instance, U.S. Pat. No. 4,922,943 to Gill suggests a system whereby water is returned to the public supply after it reaches the output point by means of faucet diverter valves, extensive return-water piping, large storage tanks, and compressed air. However, application of such a solution is costly and impractical.

The present invention proposes a more pragmatic means of significantly reducing water waste, as described above, by providing a local system of water diversion and storage prior to the point at which it reaches the outlet point.

### SUMMARY OF INVENTION

The present invention is an apparatus for conserving water in a residential, commercial or other plumbing installation where hot and/or cold water is delivered. In the case of a hot-water conserving apparatus, it would work as follows. The device is placed in an inconspicuous place, such as in a cabinet under a sink, and is connected to the water lines. The hot water temperature and flow are continuously monitored. If hot water flow is detected (by turning on the hot water faucet, for instance), and if the hot water temperature is below a preset “Diversion Temperature”, it is diverted and flows into the apparatus for storage. When the temperature of the water rises above a preset “Delivery Temperature”, or when the available storage volume of the apparatus is consumed, diversion of the hot water is stopped and it flows, as normal, to the outlet point (the faucet) and then, for instance, into a sink. The water in storage, being below the diversion temperature, is then directed to the cold-water side of the system. This invention could greatly reduce the amount of water that would normally flow to a drain as a person waits for the hot water to reach a preferred temperature. A similar method can be employed for conserving cold water in a hot environment.

### BRIEF DESCRIPTION OF DRAWINGS

FIG. 1 is a diagram showing a possible installation of a Water Saver apparatus.

FIG. 2 is a schematic representation of a Hot Water Saver apparatus. Hot water 3 enters the system 1 at connection point 7, exits the system at connection point 9, and flows to delivery point 5, which may be, for example, a faucet. Cold water 4 enters the system at connection point 8, exits the system at connection point 10, and flows to delivery point 6.

FIG. 3 is a schematic representation of a Cold Water Saver apparatus. Cold water 4 enters the system 1 at connection point 7, exits the system at connection point 9, and flows to delivery point 5, which may be, for example, a faucet. Hot water 3 enters the system at connection point 8, exits the system at connection point 10, and flows to delivery point 6.

### DETAILED DESCRIPTION

Water Saver

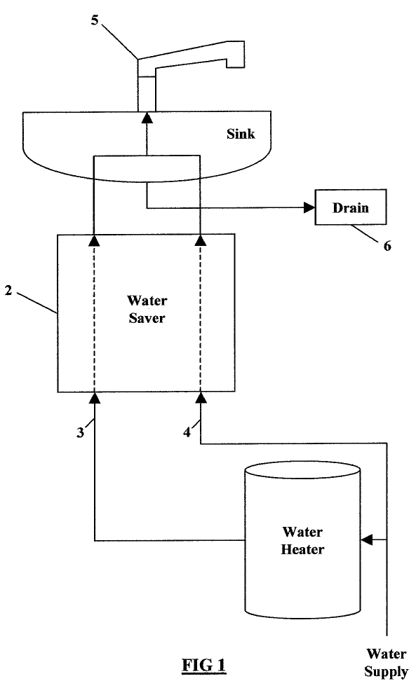

Referring to FIG. 1, the Water Saver 2 is installed between the water supply lines 3, 4 and the water outlet point 5 (in this case a faucet on a sink). Other possibilities for installation include a Water Saver installed in a shower, a bath, a household appliance such as a dishwasher or clothes washer, a carwash, a commercial processing machine or machine tool, and the like. The Water Saver monitors the temperature and flow of water through the apparatus and stores and reroutes the water as necessary to reduce the possibility of water flowing to the drain 6. The Water Saver apparatus can be AC or DC powered, and, if DC powered, may recharge by means of energy induced or generated by water flow through the apparatus.

Hot Water Saver

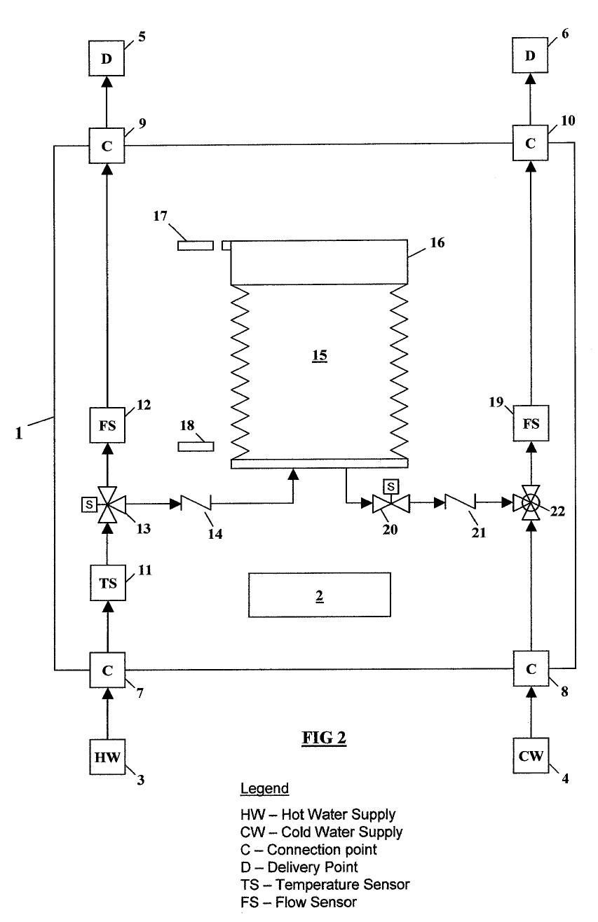

Referring to FIG. 2, Hot water 3 flows into the Hot Water Saver apparatus 1 at connection point 7, and cold water 4 flows into the system at connection point 8. A temperature sensor 11 and a flow sensor 12 monitor the temperature and flow of hot water through the apparatus. When hot-water flow is detected (for example, when the hot water faucet is opened), and if the temperature of the water is below a preset “Diversion Temperature”, and if the storage tank 15 is not full, then some or all of the water is diverted into the storage tank via a diverter valve 13. The water continues to flow into the storage tank until the temperature of the water rises above a preset “Delivery Temperature”, or until the storage tank is full. A check valve 14 prevents backflow of the water into the diverter valve 13. Level sensors 17 and 18 monitor the water level in the storage tank. Sensor 17 is used to indicate a “maximum level” condition and to stop the diversion of water in the case where the storage tank has filled to capacity, yet the temperature of the water has not risen above the Delivery Temperature. Sensor 18 is used to indicate a “minimum level” condition and to close the valve 20 when it is open. Temperature sensor 11 may be located remotely with respect to the apparatus, for example, on a water supply pipe.

Another flow sensor 19 monitors the flow of cold water through the apparatus. When cold water flow is detected (for example, when the cold water faucet is opened), and if the water level in the storage tank 15 is above a minimum level as indicated by level sensor 18, then a valve 20 is opened, and the water in the storage tank flows into a mixing valve 22 where it is mixed with the cold water flowing through the apparatus. A check valve 21 prevents backflow of the water into the storage tank 15. When the level of water in the storage tank 15 falls below the minimum level as indicated by level sensor 18, the valve 20 is closed. The valve is not allowed to re-open until a preprogrammed amount of time has passed or until the storage tank reaches its maximum level again.

The apparatus has a means of providing pressurized water delivery to the mixing valve 22. This is accomplished by means of a bellows-type storage tank 15 and a weight 16 placed atop the tank. The amount of weight is predetermined such that it generates less pressure than the incoming water pressure at check valve 14. Alternatively, a stiff-walled pressure-vessel storage tank can be used, with pressure generated by compressing air as the tank is filled or from an external source of compressed air. In this case, one or both of sensors 17 and 18 can be pressure sensors instead of level sensors. The mixing valve 22 is designed such that water can exit the tank and mix with the incoming cold water at a pressure lower than the incoming cold-water pressure.

Cold Water Saver

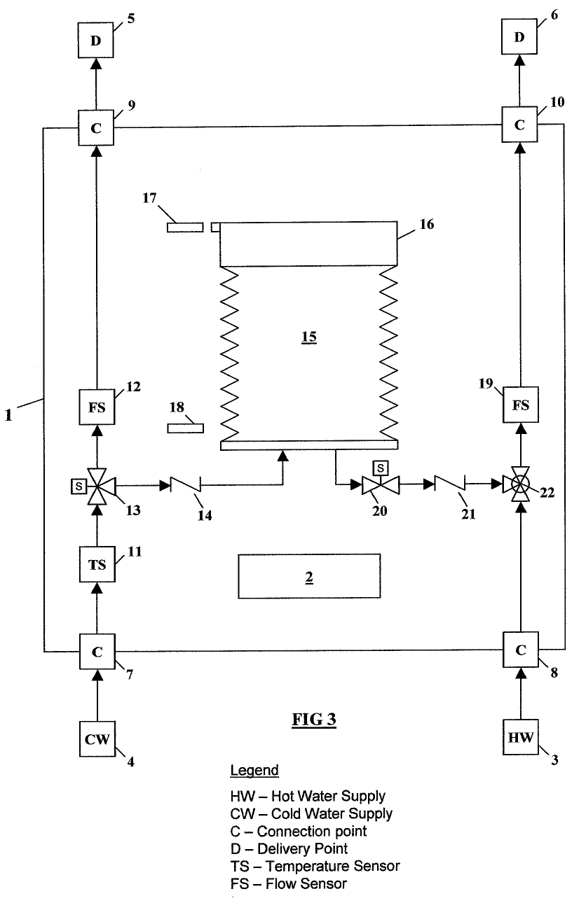

Referring to FIG. 3, cold water 4 flows into the Cold Water Saver apparatus 1 at connection point 7, and hot water 3 flows into the apparatus at connection point 8. A temperature sensor 11 and a flow sensor 12 monitor the temperature and flow of cold water through the apparatus. When cold-water flow is detected (for example, when the cold water faucet is opened), and if the temperature of the water is above a preset “Diversion Temperature”, and if the storage tank 15 is not full, then some or all of the water is diverted into the storage tank via a diverter valve 13. The water continues to flow into the storage tank until the temperature of the water falls below a preset “Delivery Temperature”, or until the storage tank is full. A check valve 14 prevents backflow of the water into the diverter valve 13. Level sensors 17 and 18 monitor the water level in the storage tank. Sensor 171S used to indicate a “maximum level” condition and to stop the diversion of water in the case where the storage tank has filled to capacity, yet the temperature of the water has not fallen below the Delivery Temperature. Sensor 18 is used to indicate a “minimum level” condition and to close the valve 20 when it is open. Temperature sensor 11 may be located remotely with respect to the apparatus, for example, on a water supply pipe.

Another flow sensor 19 monitors the flow of hot water through the apparatus. When hot water flow is detected (for example, when the hot water faucet is opened), and if the water level in the storage tank 15 is above a minimum level as indicated by level sensor 18, then a valve 20 is opened, and the water in the storage tank flows into a mixing valve 22 where it is mixed with the hot water flowing through the apparatus. A check valve 21 prevents backflow of the water into the storage tank 15. When the level of water in the storage tank 15 falls below the minimum level as indicated by level sensor 18, the valve 20 is closed. The valve is not allowed to re-open until a preprogrammed amount of time has passed or until the storage tank reaches its maximum level again.

The apparatus has a means of providing pressurized water delivery to the mixing valve 22. This is accomplished by means of a bellows-type storage tank 15 and a weight 16 placed atop the tank. The amount of weight is predetermined such that it generates less pressure than the incoming water pressure at check valve 14. Alternatively, a stiff-walled pressure-vessel storage tank can be used, with pressure generated by compressing air as the tank is filled or from an external source of compressed air. In this case, one or both of sensors 17 and 18 can be pressure sensors instead of level sensors. The mixing valve 22 is designed such that water can exit the tank and mix with the incoming hot water at a pressure lower than the incoming hot-water pressure.

1. An apparatus for conserving hot water usage in a plumbing installation, comprising:
A means of diverting incoming hot water into a local storage tank when the temperature of said water is below a desired temperature;
A means of delivering said stored water from the local storage tank to the cold-water side of the plumbing installation when cold water is called for;
A means of setting the temperature below which hot water will be diverted into the storage tank;
Sensors for monitoring the water level in the storage tank;
A microprocessor for controlling the water-saving process.

2. An apparatus for conserving cold water usage in a plumbing installation, comprising:
A means of diverting incoming cold water into a local storage tank when the temperature of said water is above a desired temperature;
A means of delivering said stored water from the local storage tank to the hot-water side of the plumbing installation when hot water is called for;
A means of setting the temperature above which cold water will be diverted into the storage tank;
Sensors for monitoring the water level in the storage tank;
A microprocessor for controlling the water-saving process.

3. An apparatus of both claim 1 and claim 2.

4. An apparatus of claim 1 or claim 2, or an apparatus of both claim 1 and claim 2, wherein the storage tank changes size depending on the quantity of water stored within it.

5. An apparatus of claim 1 or claim 2, or an apparatus of both claim 1 and claim 2, and which is installed in:
a sink, lavatory, bath or shower;
a household appliance, such as a dishwasher or clothes washer;
a carwash, a commercial processing machine, or machine tool.

6. An apparatus of claim 1 or claim 2, or an apparatus of both claim 1 and claim 2, and which is DC powered, and which is recharged by means of energy induced by or generated from water flow through the apparatus.
